(19) United States
(12) Patent Application Publication
(10) Pub. No.: US 2013/0113880 A1
(43) Pub. Date: May 9, 2013

(54) High Efficiency Video Coding (HEVC) Adaptive Loop Filter

(71) Applicants: Jie ZHAO, Vancouver, WA (US); Christopher A. SEGALL, Camas, WA (US)

(72) Inventors: Jie ZHAO, Vancouver, WA (US); Christopher A. SEGALL, Camas, WA (US)

(21) Appl. No.: 13/291,981

(22) Filed: Nov. 8, 2011

(51) Int. Cl. H04N 7/26; H04N 13/00

(52) U.S. Cl. 348/43; 375/240.02; 375/E07.126; 348/E13.062

(57) ABSTRACT

A High Efficiency Video Coding (HEVC) receiver is provided with a method for adaptive loop filtering. The receiver accepts digital information representing an image, and adaptive loop filter (ALF) parameters with no DC coefficient of weighting. The image is reconstructed using the digital information and estimates derived from the digital information. An ALF filter is constructed from the ALF parameters, and is used to correct for distortion in the reconstructed image. Typically, the receiver accepts a flag signal to indicate whether the DC coefficients have been transmitted or not. In other aspects, center luma coefficients are estimated from other coefficients, and the use of k values is simplified.

### BACKGROUND OF THE INVENTION

1. Field of the Invention

This invention generally relates to digital image processing and, more particularly to a system and method for optimizing the adaptive loop filtering of compressed video image characteristics.

2. Description of the Related Art

As noted in Wikipedia, High Efficiency Video Coding (HEVC) is a draft video compression standard, a successor to H.264/MPEG-4 AVC (Advanced Video Coding), currently under joint development by the ISO/IEC Moving Picture Experts Group (MPEG) and ITU-T Video Coding Experts Group (VCEG). MPEG and VCEG have established a Joint Collaborative Team on Video Coding (JCT-VC) to develop the HEVC standard. It has sometimes been referred to as “H.265”, since it is considered the successor of H.264, although this name is not commonly used within the standardization project. In MPEG, it is also sometimes known as “MPEG-H”. However, the primary name used within the standardization project is HEVC.

HEVC aims to substantially improve coding efficiency compared to AVC High Profile, i.e. to reduce bitrate requirements by half with comparable image quality, probably at the expense of increased computational complexity. Depending on the application requirements, HEVC should be able to trade off computational complexity, compression rate, robustness to errors and processing delay time.

HEVC is targeted at next-generation HDTV displays and content capture systems which feature progressive scanned frame rates and display resolutions from (VGA (320×240) up to 1080p and Ultra HDTV (7680×4320), as well as improved picture quality in terms of noise level, color gamut and dynamic range.

The HEVC draft design includes various coding tools, such as
Tree-structured prediction and residual difference block segmentation
Extended prediction block sizes (up to 64×64)
Large transform block sizes (up to 32×32)
Tile and slice picture segmentations for loss resilience and parallelism
Wavefront processing structure for decoder parallelism
Square and non-square transform block sizes
Integer inverse transforms
Directional intra prediction with a large number of prediction types (up to 35 per prediction block size)
Mode-dependent sine/cosine transform type switching
Adaptive motion vector predictor selection
Temporal motion vector prediction
Multi-frame motion compensation prediction
High-accuracy motion compensation interpolation (8 taps)
Increased hit depth precision
De-blocking filter
Adaptive loop filter (ALF)
Sample adaptive offset (SAO)
Entropy coding using one of two selectable types:
Context-adaptive binary arithmetic coding (CABAC)
Context-adaptive variable-length coding (CAVLC)

It has been speculated that these techniques are most beneficial with multi-pass encoding.

FIGS. 1A and 1B are diagrams depicting star shape and cross shape ALF filters, respectively (prior art). The star-shape filter preserves the directionality while only using 9 coefficients. The cross-shape has a much reduced horizontal size 11 as compared to the previously adopted 19×5. The current encoding algorithm to utilize the proposed two new shapes consists of the following three steps (same as in HM3.1-dev-adcs):

1. Using only block-based classification (BA), evaluate two sets of filter using the respective shapes. Select the shape which provides better rate-distortion efficiency.

2. After filter shape has been decided, evaluate region-based classification to determine to use block-based filter adaptation (BA) or region-based filter adaptation (RA).

3. Finally, a CU-adaptive on/off decision is performed using the filters of the selected shape (from Step 1) and classification method (from Step 2).

The encoding algorithm (same as HM3.1-dev-adcs), for each frame is as follows:

1. Using block-based classification (BA), evaluate two sets of filter with the two shapes. Select the shape which provides better rate-distortion efficiency.

2. After filter shape has been decided, evaluate region-based classification (RA) to determine using BA or RA.

3. Finally, a CU-adaptive on/off decision is performed using the filters of the selected shape (from Step 1) and classification method (from Step 2).

FIG. 9 is a flowchart illustrating a method for constructing an ALF filter (prior art). In Step 900 a video decoder accepts ALF parameters that always include a DC coefficient. In Step 902 the ALF filter or filters are constructed using the ALF parameters. In Step 904 the ALF filter or filters are used to correct for distortion in a decoded image.

FIG. 10 is a flowchart illustrating a method for constructing an ALF luma filter (prior art). In Step 1000 a flag bit is received. If the filter_pred_flag or filter_index flag is set to zero, the method goes to Step 1002, and actual C₀ through Cₙ coefficients are received by the decoder, along with a DC coefficient. Otherwise in Step 1004 a difference value is received for the C₀ through Cₙ coefficients, and DC coefficient, that is the difference between a previous filter and an instant filter. In Step 1006 the difference values are combined with the previous filter coefficients. Step 1008 determines if additional filters need to be constructed, and Step 1010 begins using the ALF filters to correct for distortion in a reconstructed image.

In WD 4 [JCTVC-F747, “Adaptation Parameter Set (APS),” 6th JCT-VC Meeting, Torino, July. 2011], ALF luma coefficients are sent by kth order Golomb codes (see Table 1, below). The k values are stored and sent as alf_golomb_index_bit, which can be referred to as a k table. AlfMaxDepth is not defined in working draft, however, it is likely that the term refers to the number of k values need to be received. Several filter coefficients may share the same k. There is a fixed mapping from the filter coefficients position to the k table. In HM4.0, this mapping is defined by the following arrays for star and cross shape filters respectively, where the array index corresponds to the filter coefficients position as shown in FIGS. 1A and 1B, and the array value corresponds to the index in k table. Coefficients have the same index to the k table share the same k. A k value at an entry can only increase by 0 or 1 from its previous entry.

| | |
|---|---|
| // Shape0 : star | // Shape1: cross |
| Int depthIntShape0Sym[10] = | Int depthIntShape1Sym[9] = |
| { | { |
| 1, 3, 1, | 9, |
| 3, 4, 3, | 10, |
| 3, 4, 5, 5 | 6, 7, 8, 9,10,11,11 |
| }; | }; |

It would be advantageous if ALF filter characteristics and k values could be communicated using a lower percentage of bandwidth.

### SUMMARY OF THE INVENTION

Described herein are processes that both simplify and improve upon current adaptive loop filter (ALF) algorithms used in the High Efficiency Video Coding (HEVC) video compression protocols. In one aspect, the option exists to optionally send DC coefficients. Not sending DC coefficients reduces the complexity of the ALF process, and also slightly improves the coding efficiency. In another aspect, luma center coefficients are predicted from other coefficients when inter filter prediction is not used. Predicting the center coefficient is currently used with chroma ALF coefficients. This change makes luma and chroma coefficient coding consistent with each other. Further, ALF parameters may be simplified by using fixed k tables for sending luma filter coefficients. This eliminates the overhead of estimating and sending the k values used for coding luma filter coefficient, Results show that there is no coding efficiency loss by using fixed k tables. In addition, unused bits in the conventional ALF parameter syntax can be removed to reduce bandwidth usage.

Accordingly, in a HEVC receiver, a method is provided for adaptive loop filtering. The receiver accepts digital information representing an image, and ALF parameters with no DC coefficient of weighting. In one aspect, a DC_present_flag is used to indicate if the DC coefficient is present or not. The image is reconstructed using the digital information and estimates derived from the digital information. An ALF filter is constructed from the ALF parameters, and used to correct for distortion in the reconstructed image. Typically, the receiver accepts a flag signal to indicate whether the DC coefficients have been transmitted or not.

In another aspect, the receiver accepts digital information representing an image, an inter filter prediction flag (e.g., alf_pred_method==0), ALF luma parameters including C₀ through C₍ₙ₋₁₎ coefficients of weighting, and a value indicating a difference between an estimate of a Cₙ coefficient and an actual value of the Cₙ coefficient. The image is reconstructed using the digital information and estimates derived from the digital information. The estimate of the Cₙ coefficient is calculated using the C₀ through C₍ₙ₋₁₎ coefficients. The actual Cₙ coefficient is calculated using the estimate of the Cₙ coefficient and the difference value. Then, an ALF luma filter is constructed from the C₀ through Cₙ coefficients, using the actual Cₙ coefficient, and used to correct for distortion in the reconstructed image. Additional filters may be constructed in the same manner.

In another aspect, the receiver accepts digital information representing an image, k values kₘᵢₙ through kₘₐₓ, where kₘᵢₙ is greater than k₅, and a cross filter shape command. After reconstructing the image, the kₘᵢₙ through kₘₐₓ values are used to receive adaptive loop filter (ALF) luma coefficients of weighting. These ALF luma coefficients are used to construct a cross shape ALF luma filter to correct for distortion in the reconstructed image.

In one additional aspect, the receiver accepts digital information representing an image, and a flag indicating a filter classification method. The receiver also accepts an n-bit field associated with the filter classification method. After reconstructing the image, a filter class is mapped to a filter index in response to receiving the n-hit field. Then, an ALF luma filter is constructed using the filter index, to correct for distortion in the reconstructed image.

In a related aspect, the receiver accepts digital information representing an image, and a command indicating an ALF shape. After reconstructing the image, a table of k values is accessed from local memory, where the k values are cross-referenced to the filter shape. These accessed k values are used to receive ALF luma coefficients of weighting, so that a ALF luma filter can be constructed to correct for distortion in the reconstructed image.

Additional details of the above-described methods are provided below.

### BRIEF DESCRIPTION OF THE DRAWINGS

FIGS. 1A and 1B are diagrams depicting star shape and cross shape ALF filters, respectively (prior art).

FIG. 2 is a schematic block diagram depicting a system for encoding and decoding compressed video data.

FIG. 3 is a flowchart illustrating a method for adaptive loop filtering in a High Efficiency Video Coding (HEVC) receiver.

FIG. 4 is a flowchart illustrating a method for adaptive loop filtering in a HEVC receiver using luma coefficients.

FIG. 5 is a flowchart combining aspects from the method of FIG. 4 with the conventional process depicted in FIG. 10.

FIG. 6 is a flowchart illustrating one more variation in a method for adaptive loop filtering in a HEVC receiver using luma coefficients.

FIG. 7 is a flowchart illustrating another variation in a method for adaptive loop filtering in a HEVC receiver using luma coefficients.

FIG. 8 is a flowchart illustrating yet another method for adaptive loop filtering in a HEVC receiver using luma coefficients.

FIG. 9 is a flowchart illustrating a method for constructing an ALF filter (prior art).

FIG. 10 is a flowchart illustrating a method for constructing an ALF luma filter (prior art).

FIG. 11 is a flowchart combining aspects of the method of FIG. 3 with the convention methods depicted in FIG. 9.

FIG. 12 is a block diagram illustrating one configuration of an electronic device 102 in which systems and methods may be implemented in support the ALF filtering processes described above.

FIG. 13 is a block diagram illustrating one configuration of an electronic device 570 in which systems and methods may be implemented in support of the ALF filtering processes.

### DETAILED DESCRIPTION

As used in this application, the terms “component,” “module,” “system,” and the like may be intended to refer to an automated computing system entity, such as hardware, firmware, a combination of hardware and software, software, software stored on a computer-readable medium, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

The video compression encoders and decoders described below may be generally described as computer devices that typically employ a computer system with a bus or other communication mechanism for communicating information, and a processor coupled to the bus for processing information. The computer system may also include a main memory, such as a random access memory (RAM) or other dynamic storage device, coupled to the bus for storing information and instructions to be executed by processor. These memories may also be referred to as a computer-readable medium. The execution of the sequences of instructions contained in a computer-readable medium may cause a processor to perform some of the steps associated with monitoring a handheld device that is supposed to be operating exclusively in a test mode. Alternately, some of these functions may be performed in hardware. The practical implementation of such a computer system would be well known to one with skill in the art.

As used herein, the term “computer-readable medium” refers to any medium that participates in providing instructions to a processor for execution. Such a medium may take many forms, including but not limited to, non-volatile media, volatile media, and transmission media. Non-volatile media includes, for example, optical or magnetic disks. Volatile media includes dynamic memory. Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

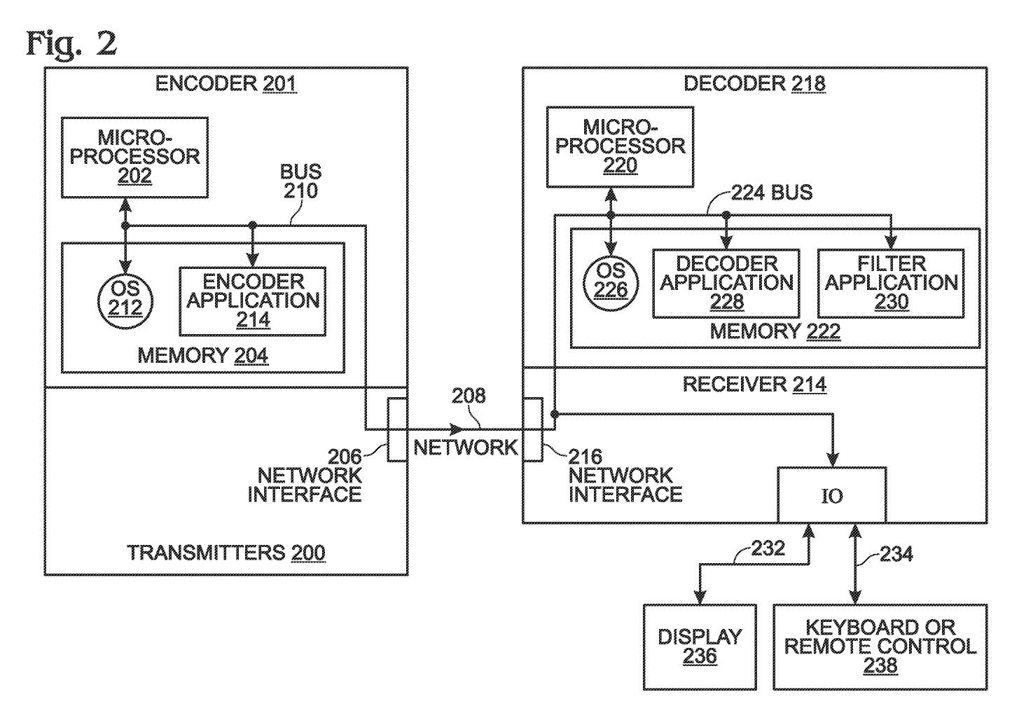

FIG. 2 is a schematic block diagram depicting a system for encoding and decoding compressed video data. The transmitter 200 may be a personal computer (PC), Mac computer, tablet, workstation, server, or a device dedicated solely to video processing. The encoder 201 includes a microprocessor or central processing unit (CPU) 202 that may be connected to memory 204 via an interconnect bus 210. The processor 202 may include a single microprocessor, or may contain a plurality of microprocessors for configuring the computer device as a multi-processor system. Further, each processor may be comprised of a single core or a plurality of cores. The memory 204 may include a main memory, a read only memory, and mass storage devices such as various disk drives, tape drives, etc. The main memory typically includes dynamic random access memory (DRAM) and high-speed cache memory. In operation, the main memory stores at least portions of instructions and data for execution by the processor 202.

The memory 204 may also comprise a mass storage with one or more magnetic disk or tape drives or optical disk drives, for storing data and instructions for use by processor 202. For a workstation PC, for example, at least one mass storage system in the form of a disk drive or tape drive, stores the operating system and application software. The mass storage may also include one or more drives for various portable media, such as a floppy disk, a compact disc read only memory (CD-ROM), or an integrated circuit non-volatile memory adapter (i.e. PC-MCIA adapter) to input and output data and code to and from the transmitter device 200.

The encoding function is performed by cooperation between microprocessor 202 and an operating system (OS) 212, enabled as a sequence of software instructions stored in memory 204 and operated on by microprocessor 202. Likewise, the encoder application 214 may be enabled as a sequence of software instructions stored in memory 204, managed by OS 212, and operated on by microprocessor 202. Alternatively but not shown, a single-purpose (video) microprocessor may be used that is managed by an Instruction. Set Architecture (ISA) enabled as a sequence of software instructions stored in memory and operated on by microprocessor, in which case the OS is not required. Alternatively but not shown, the encoding process may be at least partially enabled using hardware.

The network interface 206 may be more than one interface, shown by way of example as an interface for data communications via a network 208. The interface may be a modem, an Ethernet card, or any other appropriate data communications interface. The physical communication links may be optical, wired, or wireless. The transmitter 200 is responsible for digitally wrapping the video data compressed by the encoder 201 into a protocol suitable for transmission over the network 208.

Likewise, the receiver 214 may be more than one interface, shown by way of example as an interface 216 for data communications via a network 208. The interface may be a modem, an Ethernet card, or any other appropriate data communications interface. The physical communication links may be optical, wired, or wireless. The receiver 214 is responsive for digitally unwrapping the compressed video data from protocol used for transmission over the network 208.

The receiver 214 may be a PC, Mac computer, tablet, workstation, server, or a device dedicated solely to video processing. The decoder 218 includes a microprocessor or CPU 220 connected to memory 222 via an interconnect bus 224. The processor 220 may include a single microprocessor, or may contain a plurality of microprocessors for configuring the computer device as a multi-processor system. Further, each processor may be comprised of a single core or a plurality of cores. The memory 222 may include a main memory, a read only memory, and mass storage devices such as various disk drives, tape drives, etc. The main memory typically includes DRAM and high-speed cache memory. In operation, the main memory stores at least portions of instructions and data for execution by the processor 220.

The memory 222 may also comprise a mass storage with one or more magnetic disk or tape drives or optical disk drives, for storing data and instructions for use by processor 220. For a workstation PC, for example, at least one mass storage system in the form of a disk drive or tape drive, stores the operating system and application software. The mass storage may also include one or more drives for various portable media, such as a floppy disk, a CD-ROM, or an integrated circuit non-volatile memory adapter (i.e. PC-MCIA adapter) to input and output data and code to and from the receiver 214.

The decoding function is performed by cooperation between microprocessor 220 and an OS 226, enabled as a sequence of software instructions stored in memory 222 and operated on by microprocessor 220. Likewise, the decoder application 228 and filter application 230 may be enabled as a sequence of software instructions stored in memory 222, managed by OS 226, and operated on by microprocessor 220. Alternatively but not shown, a single-purpose (video) microprocessor may be used that is managed by an ISA enabled as a sequence of software instructions stored in memory and operated on by microprocessor, in which case the OS is not required. Alternatively but not shown, the decoding and filtering processes may be at least partially enabled using hardware.

The receiver 214 may further include appropriate input/output (IO) ports on lines 232 and 234 for user interface interconnection, respectively, with a display 236 and a keyboard or remote control 238. For example, the receiver 214 may include a graphics subsystem to drive the output display. The output display 236 may include a cathode ray tube (CRT) display or liquid crystal display (LCD). The input control devices (238) for such an implementation may include the keyboard for inputting alphanumeric and other key information. The input control devices on line 234 may further include a cursor control device (not shown), such as a mouse, touchpad, touchscreen, trackball, stylus, or cursor direction keys. The links to the peripherals on line 234 may be wired connections or use wireless communications.

Loop filter parameters for a decoded video image are created and typically remain constant for a picture, and change per picture. However, some of the “per picture” parameters should be processed per slice, per tile, or per some other boundary. With respect to the issue of sub-picture granularity, there are arguments in favor and against loop filters. Parameter sets are designed to capture long-term constant properties, and not rapidly changing information.

One potential option is to send loop filter information in Picture Parameter Set (PPS) information only. This requires PPSs being sent every time loop filter parameters are updated. Unfortunately, some irrelevant data is also sent, and there are problems for systems sending PPS out of band and certain other architectures. Also, the asynchronous nature of parameter sets is violated and the loop filter would only be able to operate at the per picture level. This option has the disadvantage of needing more bits for the (redundant) transmission of PPS data other than frequently changing loop filters.

Alternatively, a new Adaptive Parameter Set (APS) may be used as synchronous PPS, akin a persistent picture header. The new APS would have one activation per picture, activated in first slice (like PPS), it would stay constant between pictures (like PPS) or may change between pictures (like picture headers). The new APS would contain only information that is expected to change frequently between pictures. Whereas PPS can be sent out of band, the new APS could be sent in-band. However, the loop filter would only be able to operate at the per picture level.

Another alternative is APS as a slice parameter set. This alternative would permit the activation of different APS in different slices of one given picture. This solution would permit changing loop filter parameters on a per slice level, which is both flexible and future proof. This solution may be inadequate (for loop filter data) if the long-term decision is to keep loop filters parameters per picture. However, a “band-aid”may be created by insuring that loop filter data needs to be the same in all oldAPs activated in a given picture.

FIG. 3 is a flowchart illustrating a method for adaptive loop filtering in a High Efficiency Video Coding (HEVC) receiver. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the method follows the numeric order of the depicted steps. The method starts at Step 300.

Step 302 accepts digital information representing an image, and adaptive loop filter (ALF) parameters with no DC coefficient of weighting. Step 304 reconstructs the image using the digital information and estimates derived from the digital information. Step 306 constructs an ALF filter from the ALF parameters. Step 308 uses the ALF filter to correct for distortion in the reconstructed image. In one aspect, accepting the ALF parameters in Step 302 includes accepting ALF parameters that may be luma, chroma, depth (3D) parameters, or combinations of the above-mentioned parameters. As is well understood in the art, video compression techniques involve the conversion of time domain image data into frequency domain information using discrete cosine transformation (DCT) and inverse DCT (IDCT) processes. The DC coefficient correlates to the zero hertz parameter. The parameters that are passed include brightness (luma), color (chroma), and dual-perspective (depth) information. In another aspect, Step 302 accepts a digital flag indicating whether the DC coefficient has been transmitted. As an alternative, the conventional process may send a DC coefficient that is used to construct the ALF filter. Additional details of the method are provided below.

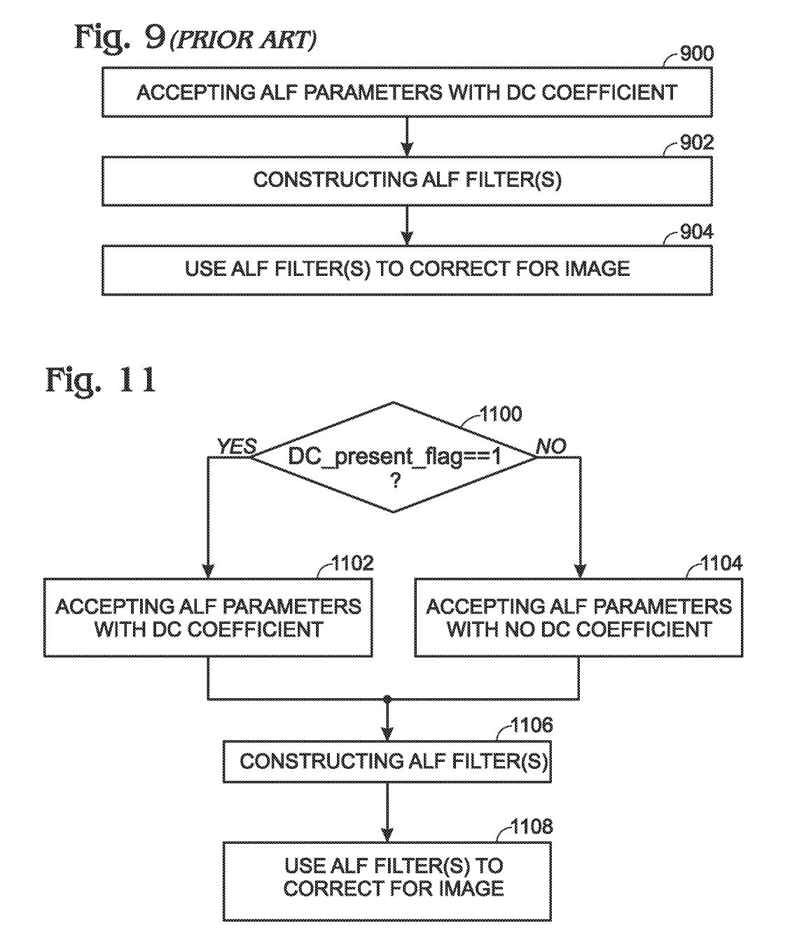

FIG. 11 is a flowchart combining aspects of the method of FIG. 3 with the convention methods depicted in FIG. 9. In Step 1100 a DC_present_flag is accepted. If the flag value is 1, the method proceeds to Step 1102 and an ALF filter is constructed using the DC coefficient. If the flag value is zero, the method goes to Step 1104 and the ALF filter is constructed without using a DC coefficient.

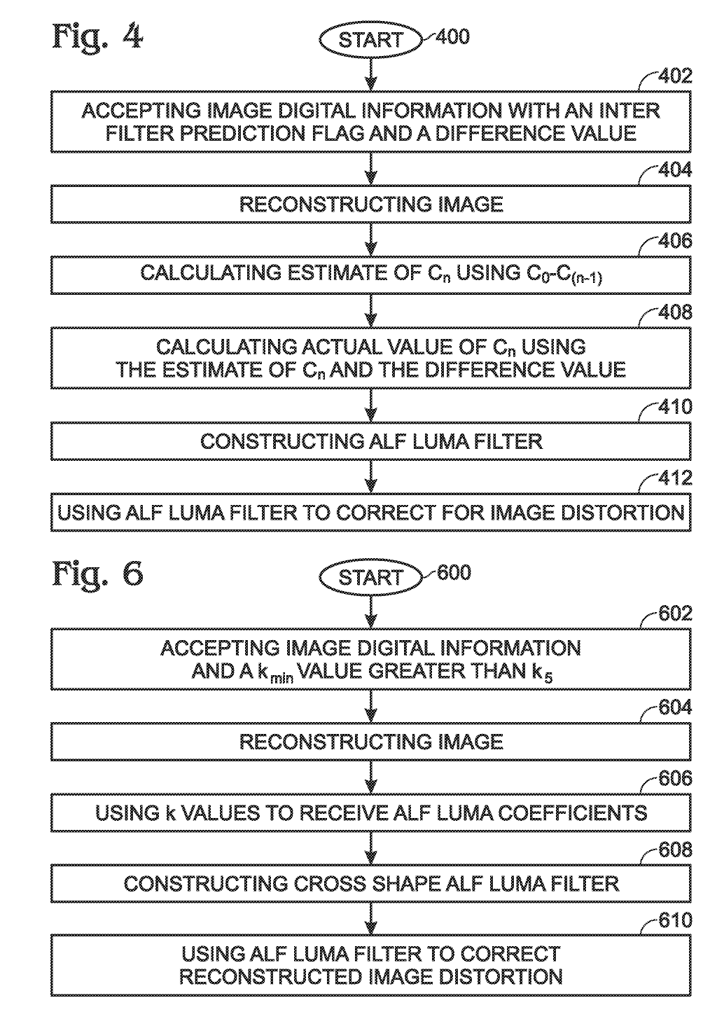

FIG. 4 is a flowchart illustrating a method for adaptive loop filtering in a HEVC receiver using luma coefficients. The method begins at Step 400. Step 402 accepts digital information representing an image, an inter filter prediction flag (e.g., alf_pred_method==0), ALF luma parameters including C₀ through C₍ₙ₋₁₎ coefficients of weighting, and a value indicating a difference between an estimate of a Cₙ coefficient and an actual value of the Cₙ coefficient. The C₀ parameter is associated with the lowest frequency DCT component (excluding the DC coefficient), with the C₁ being the next lowest frequency, etc. Note: alternate means of flagging and alternate signal names may be used to enable the method. Step 404 reconstructs the image using the digital information and estimates derived from the digital information. Step 406 calculates the estimate of the Cₙ coefficient using the C₀ through C₍ₙ₋₁₎ coefficients. Step 408 calculates the actual Cₙ coefficient using the estimate of the Cₙ coefficient and the difference value. Step 410 constructs an ALF luma filter from the C₀ through Cₙ coefficients, using the actual Cₙ coefficient. Step 412 uses the ALF luma filter to correct for distortion in the reconstructed image.

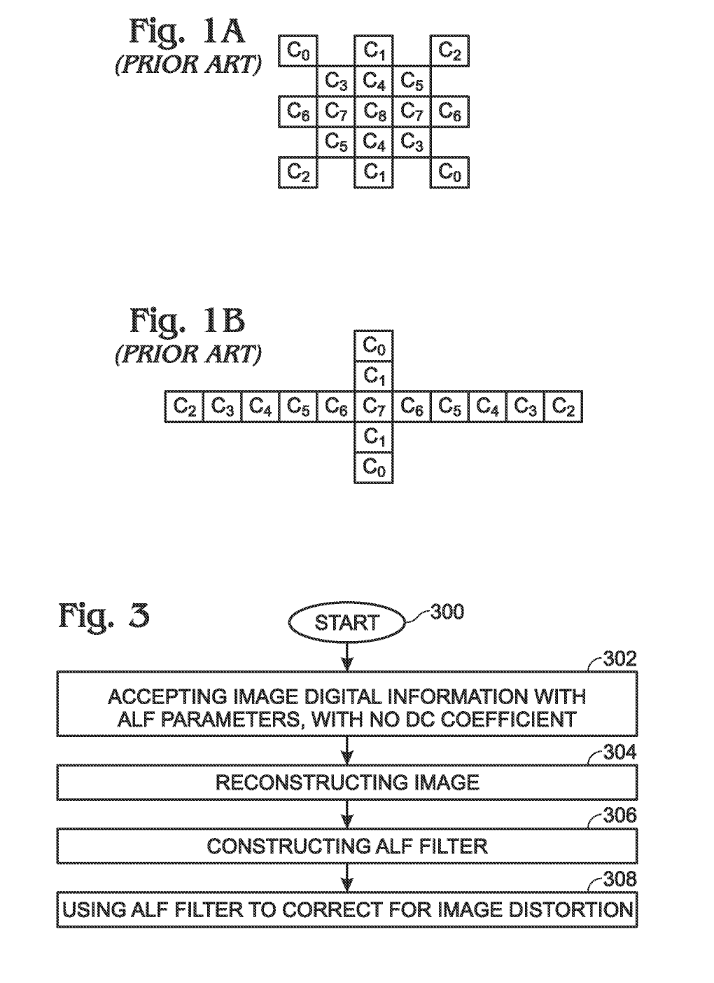

In one aspect, constructing the ALF luma filter in Step 410 includes using the Cn coefficient as the center pixel in the ALF luma filter. For example, Step 410 may construct an ALF luma filter having a star shape, where n is equal to 8. Returning briefly to FIG. 1A, in this aspect the center pixel is C₈. In another example, Step 410 constructs an ALF luma filter having a cross shape, where n is equal to 7. Returning briefly to FIG. 1B, the center pixel is C₇. Additional details of the method are provided below.

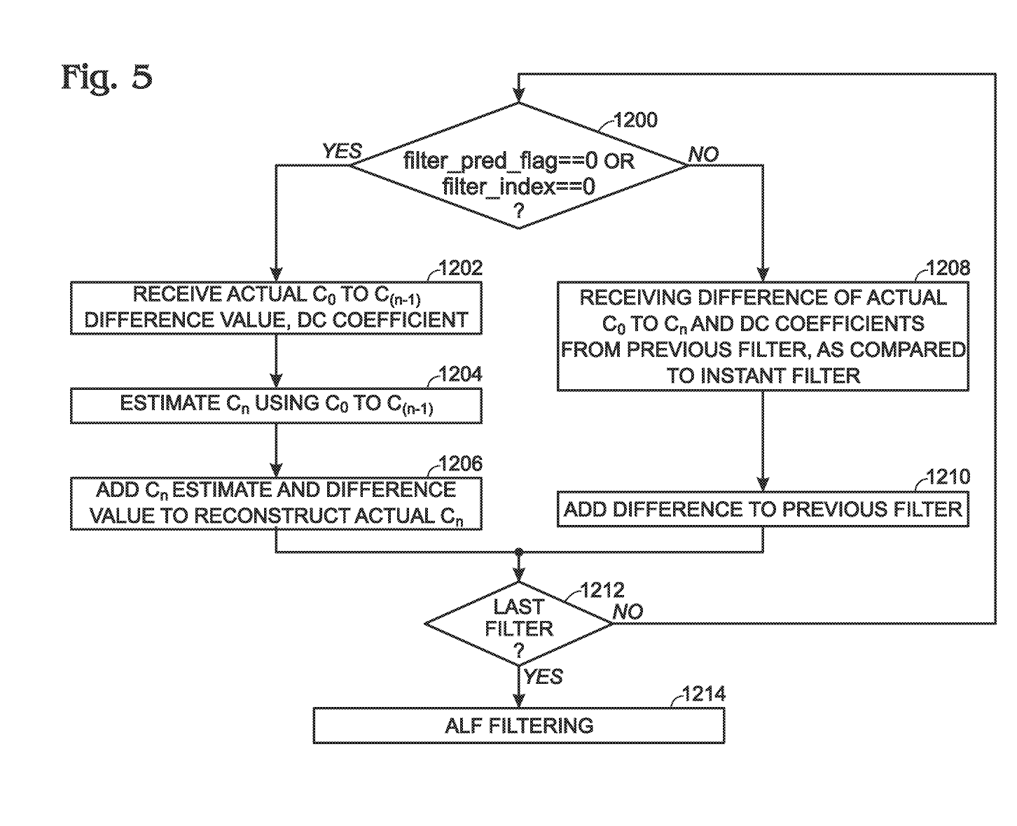

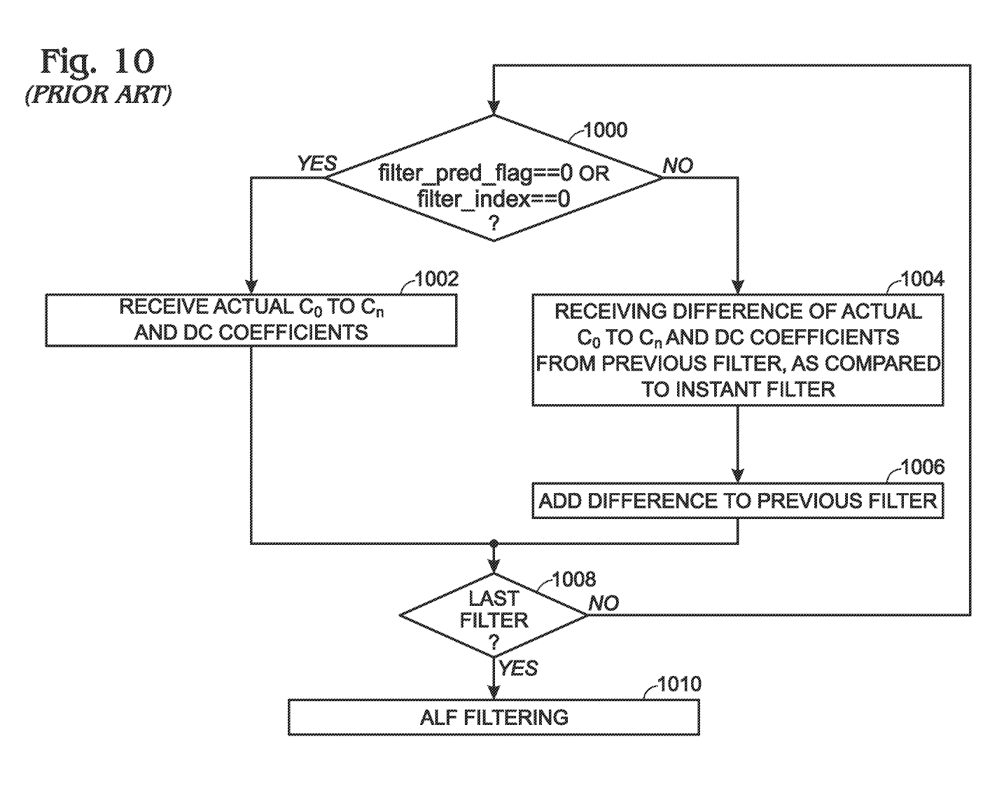

FIG. 5 is a flowchart combining aspects from the method of FIG. 4 with the conventional process depicted in FIG. 10. Step 1200 receives either a flag_pred_flag or a Filter_index flag. If the flag value is zero, the method goes to Step 1202 where the actual coefficients C0 through C(n−1) are received, along with the DC coefficient, and a value representing the difference between an estimate of the Cn coefficient and the actual Cn coefficient value. In Step 1204 the Cn estimate value is calculated, and in Step 1206 the estimate and difference value are used to find the actual Cn coefficient, so that the ALF filter can be constructed in Step 1212. Otherwise, if the flag values are 1, the method receives coefficient difference values from a previous filter in Step 1208, which are combined with the coefficients of a previous filter in Step 1210.

FIG. 6 is a flowchart illustrating one more variation in a method for adaptive loop filtering in a HEVC receiver using luma coefficients. The method begins at Step 600, Step 602 accepts digital information representing an image, k values kₘᵢₙ through kₘₐₓ, where kₘᵢₙ is greater than k₅, and a cross filter shape command. As explained in more detail below, the k₀ through k₅ values are not need for the cross shape ALF filter. Step 604 reconstructs the image using the digital information and estimates derived from the digital information. Step 606 uses the kₘᵢₙ through kₘₐₓ values to receive ALF luma coefficients of weighting. Step 608 uses the ALF luma coefficients to construct a cross shape ALF luma filter. Step 610 uses the ALF luma filter to correct for distortion in the reconstructed image. In one aspect, accepting the k values in Step 602 includes accepting a command indicting the value of kₘᵢₙ and the value of kₘₐₓ. For example, Step 602 may accept a command indicating that kₘᵢₙ=k₆ and kₘₐₓ=k₁₁. Additional details of the method are provided below.

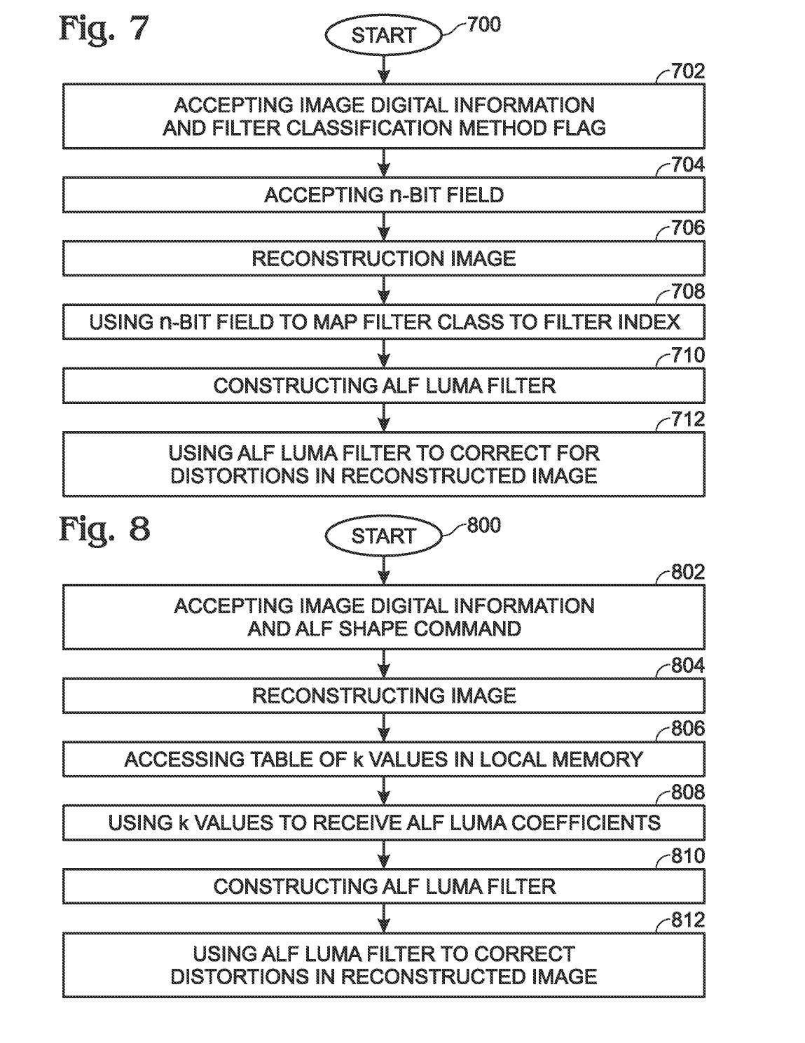

FIG. 7 is a flowchart illustrating another variation in a method for adaptive loop filtering in a HEW receiver using luma coefficients. The method begins at Step 700. Step 702 accepts digital information representing an image, and a flag indicating a filter classification method. Step 704 accepts an n-bit field associated with the filter classification method. Step 706 reconstructs the image using the digital information and estimates derived from the digital information. In response to receiving the n-bit field, Step 708 maps a filter class to a filter index. Step 710 constructs an ALF luma filter using the filter index, and Step 712 uses the ALF luma filter to correct for distortion in the reconstructed image.

In one aspect, accepting the flag indicating the filter classification method in Step 702 includes accepting a flag indicating a texture based classification method. Then accepting the n-hit field in Step 704 includes accepting a 15-hit field. In another aspect, accepting the n-bit field in Step 704 includes the value of n being dependent upon the filter classification method. Additional details of the method are provided below.

FIG. 8 is a flowchart illustrating yet another method for adaptive loop filtering in a HEVC receiver using luma coefficients. The method begins at Step 800. Step 802 accepts digital information representing an image, and a command indicating an ALF shape. Step 804 reconstructs the image using the digital information and estimates derived from the digital information. Step 806 accesses a table of k values stored in local memory, where the k values are cross-referenced to the filter shape. Step 808 uses the accessed k values to receive ALF luma coefficients of weighting. Step 810 uses the ALF luma coefficients to construct an ALF luma filter, and step 812 uses the ALF luma filter to correct for distortion in the reconstructed image.

In one aspect, accessing the table of k values in Step 806 includes accessing one of a plurality of k value tables, where each k value table is associated with a characteristic such as filter shape, predictive coding, non-predictive coding, or combinations of the above-mentioned characteristics. Addition details of the method are provided below.

Although the above-described methods have been presented individually, I should be understood that the above-described methods may be combined with each other. It should also be understood that the above-described methods may be enabled in cooperation with the system described in the explanation of FIG. 2. It should also be understood that while the methods have been described from the context of a receiver, corresponding methods may likewise be described for transmission, which would be understood from the explanation of the receiver processes.

The methods described above enable several simplifications and improvements to adaptive loop filter. Firstly, for ALF coefficients, the sending of DC coefficients, or not, can be made optional. This reduces the complexity of the ALF process, and also slightly improves the coding efficiency. An average hit rate reduction of −0.1%, −0.4%, −0.4% for Y,U,V components respectively for AI (All Infra) and RA (Random Access) configuration is obtained, with changes of 0.1%, 0.1%, and −0.1% for LD (Low Delay).

Secondly, the luma center coefficient can be predicted from other coefficients when inter filter prediction is not used. Predicting the center coefficient is already used for chroma ALF coefficients. This improvement makes luma and chroma coefficient coding consistent with each other. A luma rate reduction of −0.1% is obtained for RA and LD configurations.

Thirdly, ALF parameters are simplified by using fixed k tables for sending luma filter coefficients. This eliminates the overhead of estimating and sending the k values used by coding luma filter coefficient. Results show that there is no coding efficiency loss by using fixed k tables. In addition, there are unused bits in ALF parameter syntax that can be removed.

Adaptive Loop Filter (ALF) is used in HEW high efficiency coding configurations to find optimal filters to reduce the MSE (mean square error) between the reconstructed picture and the original picture. In the 6th JCT-VC meeting in July 2011, two filter shapes Star and Cross as shown in FIGS. 1A and 1B, were adopted. The star shape filter has 10 coefficients. It includes the C0 to C8 as shown in FIG. 1A, and a DC coefficient. The Cross shape filter has 9 coefficients. It includes C0 to C7 as shown in FIG. 1B, and a DC coefficient.

Most ALF parameters are sent in an Adaptive Parameter Set, as noted in the July 2011 meeting. The syntax of ALF parameters are as shown in the table below.

TABLE 1
ALF parameter in HM4.0

| alf_non_entropy_coded_param( ) { | | C | Descriptor |
|---|---|---|---|
| | alf_region_adaptation_flag | 2 | u(1) |
| | alf_length_luma_minus_5_div2 | 2 | ue(v) |
| | alf_no_filters_minus1 | 2 | ue(v) |
| | if (alf_no_filters_minus1 == 1) | | |

| | | |
|---|---|---|
| alf_start_second_filter | 2 | ue(v) |

else if (alf_no_filters_minus1 > 1) {

for (i=1; i< 16; i++)

| | | |
|---|---|---|
| alf_filter_pattern[i] | 2 | u(1) |

}
if (AlfNumFilters > 1)

| | | |
|---|---|---|
| alf_pred_method | 2 | u(1) |

| | | |
|---|---|---|
| alf_min_kstart_minus1 | 2 | ue(v) |
| for (i=0; i < AlfMaxDepth; i++) | | |

| | | |
|---|---|---|
| alf_golomb_index_bit[i] | 2 | u(1) |

byte_align( );

for (i=0; i< AlfNumFilters; i++)

for (j=0; j< AlfCodedLengthLuma; j++)

| | |
|---|---|
| alf_coeff_luma[i][j] | ge(v) |

| | | |
|---|---|---|
| alf_chroma_idc | 2 | ue(v) |
| if ( alf_chroma_idc ) { | | |

| | | |
|---|---|---|
| alf_length_chroma_minus_5_div2 | 2 | ue(v) |
| for( i = 0; i< AlfCodedLengthChroma; i++ ) | | |

| | |
|---|---|
| alf_coeff_chroma[i] | se(v) |

}

}

### Optional Sending DC Coefficients

As mentioned above, the Star shape filter has 10 coefficients, including a DC coefficient, and the Cross shape filter has 9 coefficients including a DC coefficient. It has been observed that DC values have wide variations, and little correlation among filters. These values take many bits to code, while the gain from DC coefficient is small for most frames, especially on low quality inter frames. Therefore, coding efficiency is optimized by making the transmission of DC coefficients optional.

In one aspect, the presence of DC coefficients is signaled once per frame, and applies to both luma and chroma filter. For example, an encoder chooses may choose to send ALF DC coefficient for the highest quality level inter frame, while not sending DC coefficients for other level inter frames and intra frames. Here, the highest quality level frames refer to those frames coded with smallest quantization parameter (QP) among inter frames.

For frames without ALF DC coefficients, the complexity of ALF process is slightly reduced with one less coefficient to apply, and the codec also saves bits on sending the DC coefficients. The syntax may be enabled as follows. The highlighted line is the addition to the syntax.

all_dc_present_flag specifies if the DC coefficient is present in the filter coefficients. If alf_dc_present_flag equals 1, the DC coefficient is present. If alf_dc_present_flag equals 0, no DC coefficient is present.

TABLE 2

| alf_non_entropy_coded_param( ) { | C | Descriptor |
|---|---|---|
| alf_region_adaptation_flag | 2 | u(1) |
| alf_length_luma_minus_5_div2 | 2 | ue(v) |
| 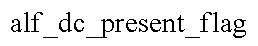 | 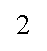 | 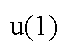 |
| . . . | | |

On average, having the option of not sending ALF DC coefficients reduces the bitrates −0.1%, −0.4% and −0.4% for Y,U,V components for AI and RA configuration, and −0.1%, 0.1%, and −0.1% for LD configurations. Full results are presented below in the results section.

In another aspect, whether the DC coefficient is present may be signaled for every filter. If alf_dc_present_flag equals 0, no DC coefficient is present, and AlfCodedLengthLuma and or AlfCodedLengthChroma are reduced by 1, i.e. 9 coefficients for star shape, and 8 coefficients for cross shape. If alf_dc_present_flag equals 1, the DC coefficient is present, and the actually DC coefficient−1 is sent in bitstream since it is known that the DC coefficient is not 0.

TABLE 3

| | | |
|---|---|---|
| . . . | | |
| for (i=0; i< AlfNumFilters; i++) | | |
| 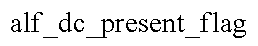 | 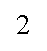 | 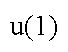 |
| for (j=0; j< AlfCodedLengthLuma; j++) | | |
| alf_coeff_luma[i][j] | | ge(v) |
| alf_chroma_idc | 2 | ue(v) |
| if ( alf_chroma_idc ) { | | |
| alf_length_chroma_minus_5_div2 | 2 | ue(v) |
| 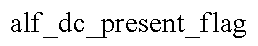 | 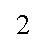 | 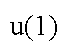 |
| for( i = 0; i< AlfCodedLengthChroma; i++) | | |
| alf_coeff_chroma[i] | | se(v) |
| } | | |

### Predicting Center Luma Coefficient

For a picture, there may be one or more ALF filters for luma. Luma coefficients may be predicted from other luma filters in the same picture. This process may be termed as inter filter prediction. If AlfNumFilters>1, there is a flag alf_pred_method to indicate whether a filter is inter filter predicted or not. As described in HEVC Working draft 4 (WD4) [2] section 8.6.3.2 (JCTVC-F800d4, “WD4: Working Draft 4 of High-Efficiency Video Coding,” 6th JCT-VC meeting, Torino, July. 2011):

The luma filter coefficients c_{L} with elements c_{L}[i][j], i=0 . . . AlfNumFilters−1, j=0 . . . AlfCodedLengthLuma−1 is derived as follows:
If alf_pred_method is equal to 0 or the value of i is equal to 0,

c_{L}[i][j]=alf_coeff_luma[i][j] (8-464)
Otherwise (alf_pred_method is equal to 1 and the value of i is greater than 1),

c_{L}[i][j]=alf_coeff_luma[i][j]+c_{L}[i−1][j] (8-465)”

For chroma, there is only one set of coefficients. Its center coefficient is predicted from other coefficients, and the difference is coded. This may be referred to as intra filter prediction. This is also described in WD4 section 8.6.3.2.

“The chroma filter coefficients cc with elements c_{C}[i], i=0 . . . AlfCodedLengthChroma−1 is derived as follows:
If i is equal to AlfCodedLengthChroma−1, the coefficient c_{C}[i] is derived as

C_{c}[i]=255−sum−alf_coeff_chroma[i]
where

sum=alf_coeff_chroma[AlfcodedLengthChroma−2]+Σⱼ(alf_coeff_chroma[j]<<1) (8-469)
with j=0 . . . AlfCodedLengthChroma−3
Otherwise (i is less than AlfCodedLengthChroma−1),

c_{C}[i]=alf_coeff_chroma[i] (8-470)”

ALF luma coefficients are sent by kth order Golomb codes. For Golamb codes, a smaller value is easier to code.

k-th order Golomb coding is a type of lossless data compression coding. It maps a value onto three sequential bit strings: a prefix, suffix and sign bit. The construction of a kth order Exp-Golomb code for value synVal is given by the following pseudo-code.

| absV = Abs( synVal ) | |
|---|---|
| stopLoop = 0 | |
| do { | |
| if( absV >= ( 1 << k ) ) { | |
| put( 1 ) | // bit of the prefix |
| absV = absV − ( 1 << k ) | |
| k++ | |
| } else { | |
| put( 0 ) | // end of prefix |

| while( k− − ) | |
|---|---|
| put( ( absV >> k ) & 1 ) // bit of suffix | |
| stopLoop = 1 | |
| } | |
| } while( !stopLoop ) | |
| if( signedFlag && synVal ! = 0) { | |
| if( synVal > 0 ) | |
| put( 0 ) | // sign bit |
| else | |
| put( 1 ) | |
| } | |

The center coefficient is typically a large value. Inter ter prediction may reduce the absolute value of the center coefficient. However for the first filter and the filters when inter filter prediction is not chosen, the center coefficient will remain to be large. Therefore, center coefficients of the predicted and the non-predicted filters have a large variation. This affects the bit rate since all the center coefficients of a picture share the same k value, and the large variation in values makes it hard to find an optimal k for all the center coefficients of that picture.

The center coefficient prediction used for chroma reduces the absolute values of a center coefficient and therefore reduces the bitrate. This process can be extended to luma coefficients when inter filter prediction is not used. Therefore, a luma filter may use the same type of center coefficient prediction method as used for the chroma filter, if alf_pred_method is equal to 0 or it is the first luma filter (i.e. i is equal to 0). This makes ALF coefficient prediction of luma and chroma more consistent.

The luma filter coefficients c_{L} with elements c_{L}[i][j], i=0 . . . AlfNumFilters−1, j=0 . . . AlfCodedLengthLuma−1 is derived as follows:
If alf_pred_method is equal to 0 or the value of i is equal to 0,
   If j is equal to AlfCodedLengthLuma−1, the coefficient c_{L}[i][j] is derived as

c_{L}[i]=255−sum−alf_coeff_luma[i][j]
where

sum=alf_coeff_luma[AlfCodedLengthLuma−2]+Σⱼ(alf_coeff_luma[i][j]<<1)
with j=0 . . . AlfCodedLengthLuma−3
Otherwise (j is less than AlfCodedLengthLuma−1),

c_{L}[i][j]=alf_coeff_luma[i][j]
Otherwise (alf_pred_method is equal to 1 and the value of i is greater than 1),

c_{L}[i][j]=alf_coeff_luma[i][j]+c_{L}[i−1][j]

### Simplification of ALF Parameters

Referring again the Table 1, the conventional ALF parameters are listed, and two syntaxes to be addressed are:

“alf_filter_pattern[i] specifies the filter index array corresponding to i-th variance index of luma samples, . . . ”

“alf_golomb_index_bit specifies the difference in order k of k-th order exponential Golomb code for the different groups of the luma filter coefficients. Note that there are several groups of the luma filter coefficients where each group may have different order k.”

In WD 4, ALF luma coefficients are sent by th order Golomb codes. The k values are stored and sent as alf_golomb_index_bit, which can be referred to as a k table. AlfMaxDepth is not defined in working draft, but most likely refers to the number of k values needed to be received. Several filter coefficients may share the same k. There is a fixed mapping from the filter coefficients position to the k table. In HM4.0, this mapping is defined by the following arrays for star and cross shape filters respectively, where the array index corresponds to the filter coefficients position as shown in FIGS. 1A and 1B, and the array value corresponds to the index in the k table. Coefficients with the same index to the k table share the same k. The k value at an entry can only increase by 0 or 1 from its previous entry.

| | |
|---|---|
| // Shape0 : star | // Shape1: cross |
| Int depthIntShape0Sym[10] = | Int depthIntShape1Sym[9] = |
| { | { |
| 1, 3, 1, | 9, |
| 3, 4, 3, | 10, |
| 3, 4, 5, 5 | 6, 7, 8, 9,10,11,11 |
| }; | }; |

In HM4.0, AlfMaxDepth is assigned as the max value in the above arrays. For the star shape, the AlfMaxDepth is 5. So 5 bits are spent to send alf_golomb_index_bit. For the cross shape, AlfMaxDepth is 11 so 11 bits are spent to send alf_golomb_index_bit for cross shape filter.

### Removing Unnecessary Bits

As just mentioned above, in HM4.0, the cross shape AlfMaxDepth is set to 11. However, for the cross shape, there is no need to send the k values from entries 0 to 5 in alf_golomb_index_bit. It is simply a waste. This issue is corrected by specifying the minimum index in the k table. Further, AlfMaxDepth can be changed to a more meaningful name, for example, as in the syntax the table below

TABLE 4

for (i=AlfMinKPos; i < AlfMaxKPos ; i++)

| | | |
|---|---|---|
| alf_golomb_index_bit[i] | 2 | u(1) |

AlfMinKPos specifies the start position in the alf_golomb_index_bit table where its entry needs to be sent.
AlfMaxKPos specifies the end position in the alf_golomb_index_bit table where its entry needs to be sent.

Another minor modification to the ALF parameter syntax is for alf_filter_pattern. Depending on the alf_region_adaptation_flag, one less bit may be sent. The change is shown in the table below. If alf_region_adaptation_flag equals 1, i.e. Region Adaptive (RA) mode, numClasses=16. If alf_region_adaptation_flag equals 0, i.e. Block Adaptive (BA) mode, numClasses=15 according to current HEVC work draft 4 (JCTVC-F800d4, “WD4: Working Draft 4 of High-Efficiency Video Coding,” 6th JCT-VC meeting, Torino, July. 2011).

TABLE 5

for (i=1; i< numClasses; i++)

| | | |
|---|---|---|
| alf_filter_pattern[i] | 2 | u(1) |

### Fixed K Table for ALF Luma Coefficients

In the whole HEW bitstream syntax, the ALF luma coefficient is the only syntax element that requires the sending of k values in the bitstream for its k-th order Golomb decoding. At the encoder side, the encoder has to estimate the k values every time it codes the filter coefficients. This is required not only in the final bitstream coding step, but also in the RD optimization step. To reduce the overhead of k values, k value are shared for the different groups of the luma filter coefficients. It also restricts the k value in the k-table to an increase of 0 or 1 from its previous entry. The signaling of ALF luma coefficient is complicated.

To simply this matter, a fixed k tables may be used for each filter coefficient positions. There may be one or more tables for different filter shapes, and for whether the filer is predicted or not. Fixed k tables eliminate the overhead of estimating and sending k values, and thus reduce complexity. Further, it simplifies overall HEVC syntax by removing this special type of signaling.

Experiments show that by using fixed k tables there is no loss of the coding performance. This technique is well suited for combination with two previously described techniques of optionally not sending DC coefficients and predicting luma center coefficients, since those two techniques both restrict the coefficients to a smaller range.

### EXPERIMENTAL RESULTS

The above-described method were applied to ALF (HM4.0), and tested using common test condition (JCTVC-F700, “Common test conditions and software reference configurations,” 6th JCT-VC meeting, Torino, July. 2011).

Optionally not Sending ALF DC Coefficients

Table 6 below shows the results of optionally sending ALF DC coefficients. For intra frames, no DC is sent. For random access and low delay configurations, the ALF DC coefficient is only sent for inter frames with the lowest QP among inter frames. For frames not sending DC coefficients, the coefficient solver was modified to make the DC value always 0, and also modified so that the ALF parameters did not send DC coefficients.

TABLE 6
Results of optionally not sending ALF DC Coefficients vs. HM4.0

| | Y | U | V |
|---|---|---|---|
| | All Intra HE | | |
| Class A | 0.0% | −0.3% | −0.3% |
| Class B | −0.1% | −0.4% | −0.5% |
| Class C | −0.1% | −0.2% | −0.3% |
| Class D | −0.1% | −0.2% | −0.3% |
| Class E | −0.1% | −0.8% | −0.7% |
| Class F | −0.1% | −0.4% | −0.4% |
| Overall | −0.1% | −0.4% | −0.4% |
| | −0.1% | −0.4% | −0.4% |
| | Random Access HE | | |
| Class A | 0.0% | −0.4% | −0.5% |
| Class B | −0.1% | −0.5% | −0.5% |
| Class C | −0.1% | −0.3% | −0.3% |
| Class D | −0.1% | −0.3% | −0.5% |
| Class E | | | |
| Class F | −0.1% | −0.3% | −0.3% |
| Overall | −0.1% | −0.4% | −0.4% |
| | −0.1% | −0.4% | −0.4% |
| | Low delay B HE | | |
| Class A | | | |
| Class B | 0.0% | 0.0% | 0.1% |
| Class C | −0.1% | 0.0% | −0.2% |
| Class D | −0.1% | 0.4% | −0.4% |
| Class E | 0.1% | 0.1% | 0.4% |
| Class F | −0.2% | −0.3% | −0.3% |
| Overall | −0.1% | 0.1% | −0.1% |
| | −0.1% | 0.0% | −0.1% |

As can be seen from the above table, hit rate reductions of −0.1%, −0.4%, 0.4% for Y,U,V components are obtained respectively for AI (all intra) and RA (random access) configurations; and −0.1%, 0.1%, −0.1% for LD (low delay).

Predicting Luma Center Coefficient

The table below shows the results of predicting luma center coefficients together with removing the DC coefficient. The luma center coefficient is intra predicted when alf_pred_method is equal to 0 or the value of i is equal to 0. Comparing the results in Table 6, the results below have an additional rate reduction of about −0.1% for luma, for RA and LD configurations.

TABLE 7
Results of predicting Luma Center Coefficient and
optionally sending ALF DC Coefficients vs. HM4.0

| | Y | U | V |
|---|---|---|---|
| | All Intra HE | | |
| Class A | 0.0% | −0.3% | −0.3% |
| Class B | −0.1% | −0.4% | −0.5% |
| Class C | −0.1% | −0.2% | −0.3% |
| Class D | −0.1% | −0.2% | −0.3% |
| Class E | −0.1% | −0.9% | −0.7% |
| Class F | −0.1% | −0.4% | −0.5% |
| Overall | −0.1% | −0.4% | −0.4% |
| | −0.1% | −0.4% | −0.4% |
| | Random Access HE | | |
| Class A | −0.1% | −0.4% | −0.5% |
| Class B | −0.2% | −0.6% | −0.5% |
| Class C | −0.2% | −0.3% | −0.4% |
| Class D | −0.3% | −0.5% | −0.4% |
| Class E | | | |
| Class F | −0.3% | −0.3% | −0.3% |
| Overall | −0.2% | −0.4% | −0.4% |
| | −0.2% | −0.4% | −0.4% |
| | Low delay B HE | | |
| Class A | | | |
| Class B | 0.0% | 0.0% | −0.1% |
| Class C | −0.1% | −0.3% | −0.1% |
| Class D | −0.2% | 0.2% | 0.2% |
| Class E | −0.1% | −0.2% | 0.1% |
| Class F | −0.4% | −0.2% | −0.4% |
| Overall | −0.2% | −0.1% | −0.1% |
| | −0.2% | −0.1% | −0.1% |

ALF Parameter Simplification by Fixed K Tables

Table 8 shows the results of using fixed k tables for coding luma coefficients together with optionally not sending DC coefficients, and predicting center luma coefficients. Comparing to the Table 7 results, fixed k tables did not result in coding efficiency loss. For some sequences, it even has slight gains.

The sample tables used were:

[2, 3, 2, 4, 5, 4, 4, 5, 6, 8] for star shape.
[3, 5, 2, 3, 3, 4, 5, 6, 8] for cross shape.

More tables can additionally be defined to differentiate whether a filter Inter predicted code is used or not.

TABLE 8
Results of Fixed K Tables and predicting Luma Center Coefficient
and optionally not sending ALF DC coefficients vs. HM4.0

| | Y | U | V |
|---|---|---|---|
| | All Intra HE | | |
| Class A | 0.0% | −0.3% | −0.3% |
| Class B | −0.1% | −0.4% | −0.5% |
| Class C | −0.1% | −0.2% | −0.3% |
| Class D | −0.1% | −0.2% | −0.3% |
| Class E | −0.1% | −0.9% | −0.7% |
| Class F | −0.1% | −0.4% | −0.5% |
| Overall | −0.1% | −0.4% | −0.4% |
| | −0.1% | −0.4% | −0.4% |
| | Random Access HE | | |
| Class A | 0.0% | −0.5% | −0.6% |
| Class B | −0.2% | −0.6% | −0.5% |
| Class C | −0.2% | −0.3% | −0.4% |
| Class D | −0.3% | −0.6% | −0.6% |
| Class E | | | |
| Class F | −0.3% | −0.4% | −0.5% |
| Overall | −0.2% | −0.5% | −0.5% |
| | −0.2% | −0.5% | −0.5% |
| | Low delay B HE | | |
| Class A | | | |
| Class B | 0.0% | −0.1% | 0.1% |
| Class C | −0.1% | −0.1% | −0.1% |
| Class D | −0.2% | 0.1% | 0.0% |
| Class E | 0.0% | −0.2% | 0.3% |
| Class F | −0.4% | 0.0% | 0.0% |
| Overall | −0.2% | 0.0% | 0.0% |
| | −0.2% | 0.0% | 0.0% |

Removing Unnecessary bits from the ALF Parameters

Finally, the results of removing unnecessary hits on alf_golomb_index_bit and alf_filter_pattern are shown. This improvement is evaluated alone vs. HM4.0. Reducing these unnecessary bits has little impact to the overall bit rate. One thing to note is that it's a little surprising that reducing 5 or 6 unnecessary bit from bitstream sometimes even resulted in BD rate increase for some component. This is because the rate change affected the encoder side RD decision too. That means that the RD decision at encoder side is not always optimal.

In order to not affect evaluating other proposed tools, this small change of removing the unnecessary bits was not turned on in the experimental results associated with unsent k values and fixed k table variations described above.

TABLE 9
Results of Removing unnecessary bits on alf_golomb_index_bit
and alf_filter_pattern bit vs. HM4.0

| | Y | U | V |
|---|---|---|---|
| | All Intra HE | | |
| Class A | 0.00% | 0.00% | 0.00% |
| Class B | 0.00% | 0.00% | 0.00% |
| Class C | 0.00% | 0.00% | 0.00% |
| Class D | 0.00% | 0.00% | 0.00% |
| Class E | 0.00% | 0.00% | 0.00% |
| Class F | 0.00% | 0.00% | 0.00% |
| Overall | 0.00% | 0.00% | 0.00% |
| | 0.00% | 0.00% | 0.00% |
| | Random Access HE | | |
| Class A | 0.00% | 0.03% | 0.04% |
| Class B | 0.00% | 0.01% | 0.00% |
| Class C | −0.01% | 0.01% | −0.02% |
| Class D | −0.01% | 0.02% | −0.03% |
| Class E | | | |
| Class F | −0.01% | 0.01% | 0.00% |
| Overall | −0.01% | 0.02% | 0.00% |
| | −0.01% | 0.01% | 0.00% |
| | Low delay B HE | | |
| Class A | | | |
| Class B | 0.00% | −0.20% | −0.15% |
| Class C | −0.02% | −0.03% | −0.03% |
| Class D | 0.01% | 0.12% | 0.13% |
| Class E | 0.04% | −0.14% | 0.63% |
| Class F | −0.02% | −0.16% | −0.03% |
| Overall | 0.00% | −0.08% | 0.07% |
| | 0.00% | −0.14% | 0.04% |

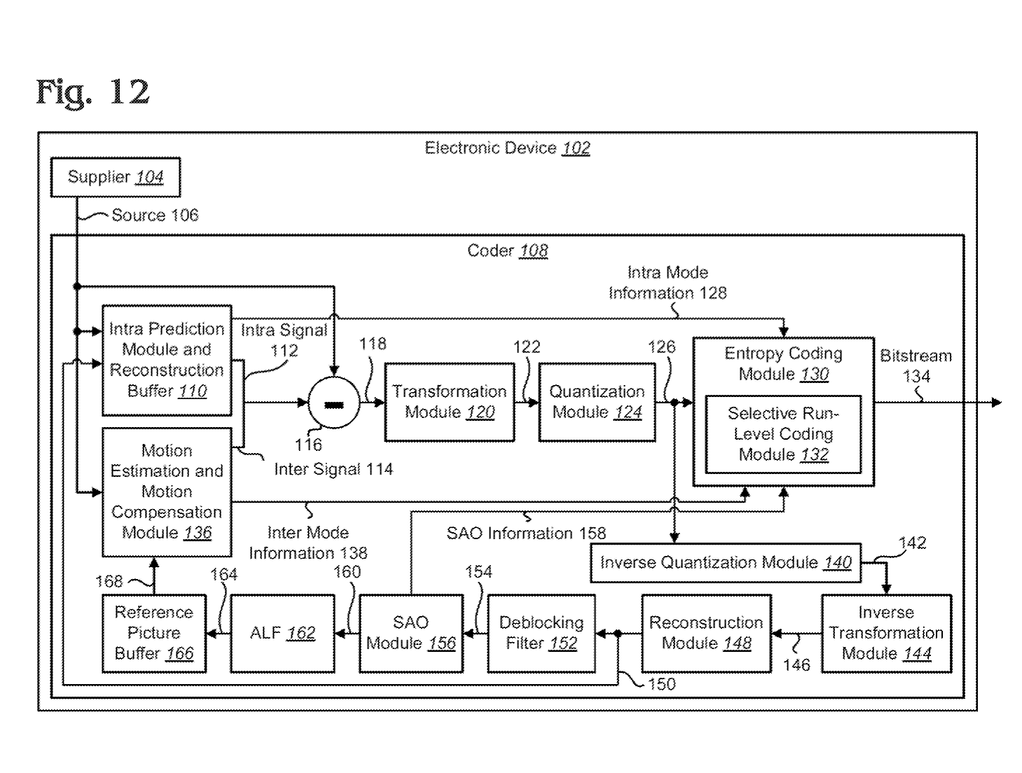

FIG. 12 is a block diagram illustrating one configuration of an electronic device 102 in which systems and methods may be implemented in support of the ALF filtering processes described above. It should be noted that one or more of the elements illustrated as included within the electronic device 102 may be implemented in hardware, software or a combination of both. For example, the electronic device 102 includes a coder 108, which may be implemented in hardware, software or a combination of both. For instance, the coder 108 may be implemented as a circuit, integrated circuit, application-specific integrated circuit (ASIC), processor in electronic communication with memory with executable instructions, firmware, field-programmable gate array (FPGA), etc., or a combination thereof. In some configurations, the coder 108 may be a high efficiency video coding (HEVC) coder.

The electronic device 102 may include a supplier 104. The supplier 104 may provide picture or image data (e.g., video) as a source 106 to the coder 108. Examples of the supplier 104 include image sensors, memory, communication interfaces, network interfaces, wireless receivers, ports, etc.

The source 106 may be provided to an intra-frame prediction module and reconstruction buffer 110. The source 106 may also be provided to a motion estimation and motion compensation module 136 and to a subtraction module 116.

The intra-frame prediction module and reconstruction buffer 110 may generate intra mode information 128 and an intra signal 112 based on the source 106 and reconstructed data 150. The motion estimation and motion compensation module 136 may generate inter mode information 138 and an inter signal 114 based on the source 106 and a reference picture buffer 166 signal 168. The reference picture buffer 166 signal 168 may include data from one or more reference pictures stored in the reference picture buffer 166.

The coder 108 may select between the intra signal 112 and the inter signal 114 in accordance with a mode. The intra signal 112 may be used in order to exploit spatial characteristics within a picture in an intra coding mode. The inter signal 114 may be used in order to exploit temporal characteristics between pictures in an inter coding mode. While in the intra coding mode, the intra signal 112 may be provided to the subtraction module 116 and the intra mode information 128 may be provided to an entropy coding module 130. While in the inter coding mode, the inter signal 114 may be provided to the subtraction module 116 and the inter mode information 138 may be provided to the entropy coding module 130.

Either the intra signal 112 or the inter signal 114 (depending on the mode) is subtracted from the source 106 at the subtraction module 116 in order to produce a prediction residual 118. The prediction residual 118 is provided to a transformation module 120. The transformation module 120 may compress the prediction residual 118 to produce a transformed signal 122 that is provided to a quantization module 124. The quantization module 124 quantizes the transformed signal 122 to produce transformed and quantized coefficients (TQCs) 126.

The TQCs 126 are provided to an entropy coding module 130 and an inverse quantization module 140. The inverse quantization module 140 performs inverse quantization on the TQCs 126 to produce an inverse quantized signal 142 that is provided to an inverse transformation module 144. The inverse transformation module 144 decompresses the inverse quantized signal 142 to produce a decompressed signal 146 that is provided to a reconstruction module 148.

The reconstruction module 148 may produce reconstructed data 150 based on the decompressed signal 146. For example, the reconstruction module 148 may reconstruct (modified) pictures. The reconstructed data 150 may be provided to a deblocking filter 152 and to the intra prediction module and reconstruction buffer 110. The deblocking filter 152 may produce a filtered signal 154 based on the reconstructed data 150.

The filtered signal 154 may be provided to a sample adaptive off set (SAO) module 156. The SAO module 156 may produce SAO information 158 that is provided to the entropy coding module 130 and an SAO signal 160 that is provided to an adaptive loop filter (ALF) 162. The ALF 162 produces an ALF signal 164 that is provided to the reference picture buffer 166. The ALF signal 164 may include data from one or more pictures that may be used as reference pictures.

The entropy coding module 130 may code the TQCs 126 to produce a bitstream 134. The TQCs 126 may be converted to a 1D array before entropy coding. Also, the entropy coding module 130 may code the TQCs 126 using CAVLC or CABAC. In particular, the entropy coding module 130 may code the TQCs 126 based on one or more of intra mode information 128, inter mode information 138 and SAO information 158. The bitstream 134 may include coded picture data.

The entropy coding module 130 may include a selective run-level coding (SRLC) module 132. The SRLC module 132 may determine whether to perform or skip run-level coding. In some configurations, the bitstream 134 may be transmitted to another electronic device. For example, the bitstream 134 may be provided to a communication interface, network interface, wireless transmitter, port, etc. For instance, the bitstream 134 may be transmitted to another electronic device via a Local Area Network (LAN), the Internet, a cellular phone base station, etc. The bitstream 134 may additionally or alternatively be stored in memory on the electronic device 102.

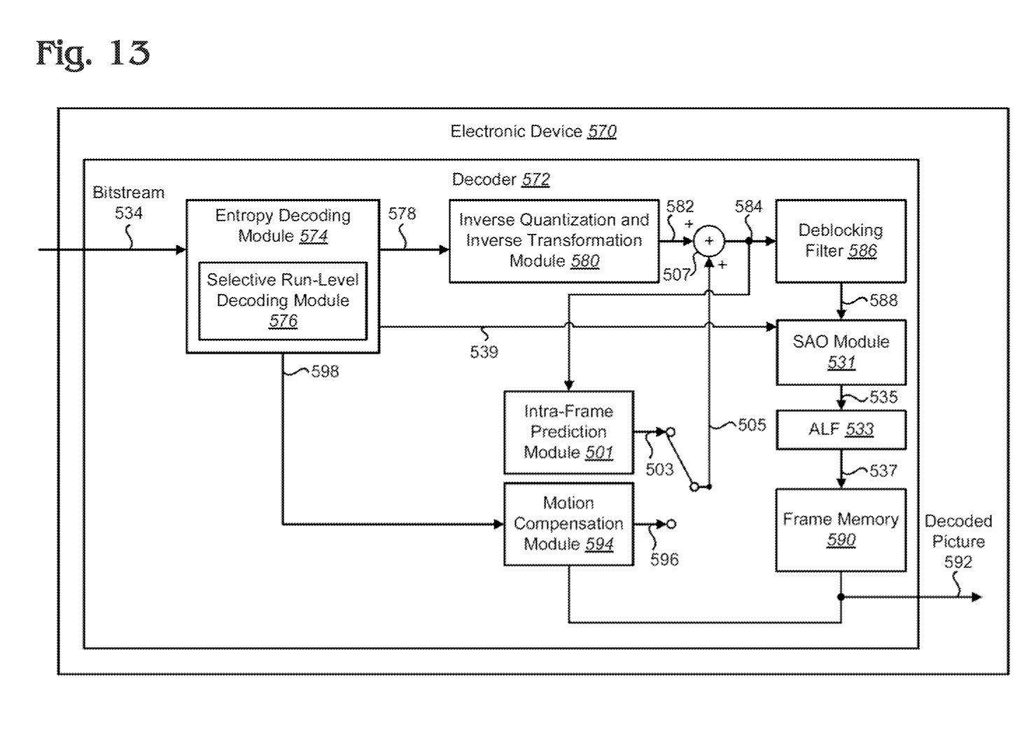

FIG. 13 is a block diagram illustrating one configuration of an electronic device 570 in which systems and methods may be implemented in support of the ALF filtering processes. In some configurations, the decoder 572 may be a high-efficiency video coding (HEVC) decoder. The decoder 572 and one or more of the elements illustrated as included in the decoder 572 may be implemented in hardware, software or a combination of both. The decoder 572 may receive a bitstream 534 (e.g., one or more coded pictures included in the bitstream 534) for decoding. In some configurations, the received bitstream 534 may include received overhead information, such as a received slice header, received picture parameter set (PPS), received buffer description information, classification indicator, etc. Received symbols (e.g., encoded TQCs) from the bitstream 534 may be entropy decoded by an entropy decoding module 574. This may produce a motion information signal 598 and decoded transformed and quantized coefficients (TQCs) 578.

The entropy decoding module 574 may include a selective run-level decoding module 576. The selective run-level decoding module 576 may determine whether to skip run-level decoding. The motion information signal 598 may be combined with a portion of a decoded picture 592 from a frame memory 590 at a motion compensation module 594, which may produce an inter-frame prediction signal 596. The decoded transformed and quantized coefficients (TQCs) 578 may be inverse quantized and inverse transformed by an inverse quantization and inverse transformation module 580, thereby producing a decoded residual signal 582. The decoded residual signal 582 may be added to a prediction signal 505 by a summation module 507 to produce a combined signal 584. The prediction signal 505 may be a signal selected from either the inter-frame prediction signal 596 produced by the motion compensation module 594 or an intra-frame prediction signal 503 produced by an intra-frame prediction module 501. In some configurations, this signal selection may be based on (e.g., controlled by) the bitstream 534.

The intra-frame prediction signal 503 may be predicted from previously decoded information from the combined signal 584 (in the current frame, for example). The combined signal 584 may also be filtered by a deblocking filter 586. The resulting filtered signal 588 may be provided to a sample adaptive offset (SAO) module 531. Based on the filtered signal 588 and information 539 from the entropy decoding module 574, the SAO module 531 may produce an SAO signal 535 that is provided to an adaptive loop filter (ALF) 533. The ALF 533 produces an ALF signal 537 that is provided to the frame memory 590. The ALF signal 537 may include data from one or more pictures that may be used as reference pictures. The ALF signal 537 may be written to frame memory 590. The resulting ALF signal 537 may include a decoded picture.

The frame memory 590 may include a decoded picture buffer (DPB). The frame memory 590 may also include overhead information corresponding to the decoded pictures. For example, the frame memory 590 may include slice headers, picture parameter set (PPS) information, cycle parameters, buffer description information, etc. One or more of these pieces of information may be signaled from a coder (e.g., coder 108).

The frame memory 590 may provide one or more decoded pictures 592 to the motion compensation module 594. Furthermore, the frame memory 590 may provide one or more decoded pictures 592, which may be output from the decoder 572. The one or more decoded pictures 592 may be presented on a display, stored in memory or transmitted to another device, for example.

A system and method have been provided for ALF process improvements. The methods include optionally not sending ALF DC coefficients, predicting luma center coefficients, and simplifying ALF parameters by fixed k table. The changes reduce ALF complexity, improve coding efficiency, and also make luma and chroma ALF processes more consistent. Examples of particular message structures have been presented to illustrate the invention. However, the invention is not limited to merely these examples. Other variations and embodiments of the invention will occur to those skilled in the art.

We claim:

1. In a High Efficiency Video Coding (HEVC) receiver, a method for adaptive loop filtering, the method comprising:
accepting digital information representing an image, and adaptive loop filter (ALF) parameters with no DC coefficient of weighting;
reconstructing the image using the digital information and estimates derived from the digital information;
constructing an ALF filter from the ALF parameters; and,
using the ALF filter to correct for distortion in the reconstructed image.

2. The method of claim 1 wherein accepting the ALF parameters includes accepting ALF parameters selected from a group consisting of luma, chroma, depth (3D) parameters, and combinations of the above-mentioned parameters.

3. The method of claim 1 wherein accepting the ALF parameters includes accepting a digital flag indicating whether the DC coefficient has been transmitted.

4. In a High Efficiency Video Coding (HEVC) receiver, a method for adaptive loop filtering using luma coefficients, the method comprising:
accepting digital information representing an image, an inter filter prediction flag, adaptive loop filter (ALF) luma parameters including C₀ through C₍ₙ₋₁₎ coefficients of weighting, and a value indicating a difference between an estimate of a Cₙ coefficient and an actual value of the Cₙ coefficient;
reconstructing the image using the digital information and estimates derived from the digital information;
calculating the estimate of the Cₙ coefficient using the C₀ through C₍ₙ₋₁₎ coefficients;
calculating the actual Cₙ coefficient using the estimate of the Cₙ coefficient and the difference value;
constructing an ALF luma filter from the C₀ through Cₙ coefficients, using the actual Cₙ coefficient; and,
using the ALF luma filter to correct for distortion in the reconstructed image.

5. The method of claim 4 wherein constructing the ALF luma filter includes using the en coefficient as a center pixel in the ALF luma filter.

6. The method of claim 5 wherein constructing the ALF luma filter includes the ALF luma filter having a star shape and n being equal to 8.

7. The method of claim 5 wherein constructing the ALF luma filter includes the ALF luma filter having a cross shape and n being equal to 7.

8. In a High Efficiency Video Coding (HEVC) receiver, a method for adaptive loop filtering using luma coefficients, the method comprising:
accepting digital information representing an image, k values kₘᵢₙ through kₘₐₓ, where kₘᵢₙ is greater than k₅, and a cross filter shape command;
reconstructing the image using the digital information and estimates derived from the digital information;
using the kₘᵢₙ through kₘₐₓ values to receive adaptive loop filter (ALF) luma coefficients of weighting;
using the ALF luma coefficients to construct a cross shape ALF luma filter; and,
using the ALF luma filter to correct for distortion in the reconstructed image.

9. The method of claim 8 wherein accepting the k values includes accepting a command indicting the value of kₘᵢₙ and the value of kₘₐₓ.

10. The method of claim 9 wherein accepting the command indicting the value of kₘᵢₙ and the value of kₘₐₓ includes accepting a command indicating that kₘᵢₙ=k₆ and kₘₐₓ=k₁₁.

11. In a High Efficiency Video Coding (HEVC) receiver, a method for adaptive loop filtering using luma coefficients, the method comprising:
accepting digital information representing an image, and a flag indicating a filter classification method;
accepting an n-bit field associated with the filter classification method;
reconstructing the image using the digital information and estimates derived from the digital information;
in response to receiving the n-bit field, mapping a filter class to a filter index;
constructing a ALF luma filter using the filter index; and,
using the ALF luma filter to correct for distortion in the reconstructed image.

12. The method of claim 11 wherein accepting the flag indicating the filter classification method includes accepting a flag indicating a texture based classification method; and,
wherein accepting the n-bit field includes accepting a 15-bit field.

13. The method of claim 11 wherein accepting the n-hit field associated with the filter classification method includes the value of n being dependent upon the filter classification method.

14. In a High Efficiency Video Coding (HEVC) receiver, a method for adaptive loop filtering using luma coefficients, the method comprising:
accepting digital information representing an image, and a command indicating an adaptive loop filter (ALF) shape;
reconstructing the image using the digital information and estimates derived from the digital information;
accessing a table of k values stored in local memory, where the k values are cross-referenced to the filter shape;
using the accessed k values to receive ALF luma coefficients of weighting;
using the ALF luma coefficients to construct a ALF luma filter; and,
using the ALF luma filter to correct for distortion in the reconstructed image.

15. The method of claim 14 wherein accessing the table of k values includes accessing one of a plurality of k value tables, where each k value table is associated with a characteristic selected from a group consisting of filter shape, predictive coding, non-predictive coding, and combinations of the above-mentioned characteristics.
